(19) United States
(12) Patent Application Publication
(10) Pub. No.: US 2025/0044489 A1
(43) Pub. Date: Feb. 6, 2025

(54) OPTICAL FILTER

(71) Applicant: AGC Inc., Tokyo (JP)

(72) Inventors: Motoshi NAKAYAMA, Tokyo (JP); Takahiro SAKAGAMI, Shizuoka (JP); Takashi NAGATA, Shizuoka (JP); Kazuhiko SHIONO, Fukushima (JP)

(73) Assignee: AGC Inc., Tokyo (JP)

(21) Appl. No.: 18/922,613

(22) Filed: Oct. 22, 2024

Related U.S. Application Data
(63) Continuation of application No. PCT/JP2023/015701, filed on Apr. 19, 2023.

(30) Foreign Application Priority Data
Apr. 27, 2022 (JP) 2022-073742

(51) Int. Cl. G02B 5/20; G02B 1/113; G02B 5/28

(52) U.S. Cl. CPC G02B 5/208; G02B 1/113; G02B 5/281

(57) ABSTRACT

The present invention pertains to an optical filter including: a light-absorbing material Y₉₀₀₋₁₀₀₀ having a maximum absorption wavelength in a wavelength region of 900 nm to 1,000 nm, and a dielectric multilayer film, in which the optical filter satisfies all of spectral characteristics (i-1) to (i-6), and the optical filter may satisfy spectral characteristic (i-7).

### CROSS-REFERENCE TO RELATED APPLICATIONS

This is a bypass continuation of International Patent Application No. PCT/JP2023/015701, filed on Apr. 19, 2023, which claims priority to Japanese Patent Application No. 2022-073742, filed on Apr. 27, 2022. The contents of these applications are hereby incorporated by reference in their entireties.

### TECHNICAL FIELD

The present invention relates to an optical filter that selectively transmits light in a visible light region and a specific near-infrared light region and shields light in the specific near-infrared light region.

### BACKGROUND ART

For an imaging device including a solid state image sensor, an application thereof is extended to a device that takes an image anytime during day and night, such as a monitoring camera or an in-vehicle camera. In such a device, it is necessary to acquire (color) images based on visible light and (monochrome) images based on infrared light.

Therefore, there has been studied use of an optical filter having, in addition to a near-infrared ray cut filter function for transmitting visible light and correctly reproducing an image based on the visible light, a function of selectively transmitting specific near-infrared light, that is, a dual band pass filter.

Patent Literature 1 discloses an optical filter in which a dielectric multilayer film and a resin substrate containing a near-infrared ray absorbing dye are combined, and near-infrared light around 850 nm and visible light are transmitted and other light is shielded.

### CITATION LIST

### Patent Literature

Patent Literature 1: JP2021-6901A

### SUMMARY OF INVENTION

In recent years, since laser light including a partial region of 800 nm to 1,000 nm is used in a sensor in the imaging field, an optical filter that can transmit near-infrared light of such a sensing region is required.

In contrast, the optical filter disclosed in Patent Literature 1 does not have sufficient transmittance for near-infrared light around 850 nm.

In an optical filter including a dielectric multilayer film, since an optical film thickness of the dielectric multilayer film changes depending on an incident angle of light, there is such a problem that a spectral transmittance curve changes depending on the incident angle. For example, as the incident angle of light increases, reflection characteristics shift to a short wavelength side, and as a result, the reflection characteristics may deteriorate in a region to be originally shielded. Such a phenomenon is likely to occur more strongly as the incident angle is larger. When such a filter is used, spectral sensitivity of the solid state image sensor may be affected by the incident angle. With a reduction in height of camera modules in recent years, use under a condition of a high incident angle is assumed, and therefore an optical filter that is hardly affected by an incident angle is required.

A shift in a visible light transmission region or a region switched from a short wavelength side near-infrared light shielding region to a near-infrared light transmission region can be reduced by using an absorbing material such as a dye. On the other hand, it is difficult to reduce a shift in a region switched from the near-infrared light transmission region to the near-infrared light shielding region by the absorbing material. When the shift is large only in this region, a transmitted light amount of the near-infrared light is changed depending on the incident angle, and a ratio of captured light amounts of visible light and infrared light in the solid state image sensor is also changed depending on the incident angle. As a result, color reproducibility of a (color) image based on the visible light and reproducibility of a (monochrome) image based on the infrared light may be affected.

Further, for example, when an imaging device that uses visible light and near-infrared light around 850 nm as a sensing region and a sensing device that uses near-infrared light around 940 nm as a light source are mounted on a certain device in combination, a component derived from the light source around 940 nm may be reflected as stray light in a (color) image based on the visible light or a (monochrome) image based on the infrared light generated by the imaging device. In addition, in recent years, a 3D sensing device using near-infrared light around 940 nm as a light source may also be mounted on a smartphone or the like, and light from such a device may also become stray light. Therefore, it may be desired to shield the near-infrared light around 940 nm in a sensing region of 800 nm to 1,000 nm from the viewpoint of removal of the stray light.

An object of the present invention is to provide an optical filter that has excellent transmittance for visible light and specific near-infrared light, excellent shielding properties for the specific near-infrared light, and a small shift of a spectral curve even at a high incident angle.

The present invention provides an optical filter having the following configuration.

[1] An optical filter including:
a light-absorbing material Y₉₀₀₋₁₀₀₀ having a maximum absorption wavelength in a wavelength region of 900 nm to 1,000 nm, and
a dielectric multilayer film, in which
the optical filter satisfies all of the following spectral characteristics (i-1) to (i-6).

(i-1) In a spectral transmittance curve at a wavelength of 450 nm to 600 nm and an incident angle of 0 degrees, an average transmittance T_{450-600(0deg)AVE} is 60% or more.

(i-2) In a spectral transmittance curve at a wavelength of 840 nm to 850 nm and an incident angle of 0 degrees, an average transmittance T_{840-850(0deg)AVE} is 60% or more.

(i-3) In a spectral transmittance curve at a wavelength of 930 nm to 950 nm and an incident angle of 0 degrees, a maximum transmittance T_{930-950(0deg)MAX} is 20% or less.

(i-4) In a spectral transmittance curve at a wavelength of 850 nm to 950 nm,
a wavelength λ_{IRL(0deg)(50%)} at which a transmittance is 50% at an incident angle of 0 degrees and a wavelength λ_{IRL(35deg)(50%)} at which a transmittance is 50% at an incident angle of 35 degrees satisfy the following relational expression:

|λ_{IRL(0deg)(50%)}−λ_{IRL(35deg)(50%)}|≤15 nm.

(i-5) In a spectral reflectance curve at a wavelength of 450 nm to 600 nm and an incident angle of 5 degrees, an average reflectance R_{450-600(5deg)AVE} measured from at least one main surface is 10% or less.

(i-6) In a spectral reflectance curve at a wavelength of 840 nm to 850 nm and an incident angle of 5 degrees, an average reflectance R_{840-850(5deg)AVE} measured from at least one main surface is 10% or less.

According to the present invention, an optical filter that has excellent transmittance for visible light and specific near-infrared light and excellent shielding properties for the specific near-infrared light even at a high incident angle can be provided. The optical filter according to the present invention is particularly excellent in transmittance in a near-infrared light region of 840 nm to 850 nm which is the sensing wavelength region even at a high incident angle, and excellent in shielding properties in a near-infrared light region of 930 nm to 950 nm. Further, the optical filter is an optical filter in which a spectral transmittance curve of a boundary region between such a transmission region and a shielding region hardly shifts depending on an incident angle and is hardly affected by the incident angle.

### BRIEF DESCRIPTION OF DRAWINGS

FIG. 1 is a cross-sectional view schematically illustrating an example of an optical filter according to one embodiment.

FIG. 2 is a cross-sectional view schematically illustrating another example of the optical filter according to one embodiment.

FIG. 3 is a diagram illustrating spectral transmittance curves of glasses.

FIG. 4 is a diagram illustrating optical density curves of glasses.

FIG. 5 is a diagram illustrating a spectral transmittance curve of a glass.

FIG. 6 is a diagram illustrating an optical density curve of the a glass.

FIG. 7 is a diagram illustrating spectral transmittance curves of ceramics.

FIG. 8 is a diagram illustrating optical density curves of the ceramics.

FIG. 9 is a diagram illustrating a spectral transmittance curve of an absorption layer.

FIG. 10 is a diagram illustrating an optical density curve of the absorption layer.

FIG. 11 is a diagram illustrating spectral transmittance curves and spectral reflectance curves of an optical filter in Example 1-1.

FIG. 12 is a diagram illustrating spectral transmittance curves and spectral reflectance curves of an optical filter in Example 1-2.

FIG. 13 is a diagram illustrating spectral transmittance curves and spectral reflectance curves of an optical filter in Example 1-3.

FIG. 14 is a diagram illustrating spectral transmittance curves and spectral reflectance curves of an optical filter in Example 1-4.

FIG. 15 is a diagram illustrating spectral transmittance curves and spectral reflectance curves of an optical filter in Example 1-5.

FIG. 16 is a diagram illustrating spectral transmittance curves and spectral reflectance curves of an optical filter in Example 1-6.

FIG. 17 is a diagram illustrating spectral transmittance curves and spectral reflectance curves of an optical filter in Example 1-7.

FIG. 18 is a diagram illustrating spectral transmittance curves and spectral reflectance curves of an optical filter in Example 1-8.

### DESCRIPTION OF EMBODIMENTS

Hereinafter, embodiments of the present invention will be described.

In the present description, a near-infrared ray absorbing dye may be abbreviated as an “NIR dye”, and an ultraviolet absorbing dye may be abbreviated as a “UV dye”.

In the present description, a compound represented by a formula (I) is referred to as a compound (I). The same applies to compounds represented by other formulae. A dye composed of the compound (I) is also referred to as a dye (I), and the same applies to other dyes. In addition, a group represented by the formula (I) is also referred to as a group (I), and the same applies to groups represented by other formulae.

In the present description, internal transmittance is transmittance obtained by subtracting an influence of interface reflection from measured transmittance, which is represented by a formula of {measured transmittance (incident angle of 0 degrees)/(100−reflectance (incident angle of 5 degrees))}×100.

In the present description, the optical density represents a value converted from the (internal) transmittance by the following formula.

$$Optical density at wavelength of λ nm = - log 10 ( {iT}_{λ} / 100 )$$

iT_{λ}: (internal) transmittance at an incident angle of 0 degrees at a wavelength of λ nm

In the present description, transmittance of glass and a spectrum of transmittance of an absorption layer including a case where a dye is contained in a resin are both “internal transmittance” even when described as “transmittance”. On the other hand, transmittance measured by dissolving a dye in a solvent such as dichloromethane, transmittance of a dielectric multilayer film, and transmittance of an optical filter including the dielectric multilayer film are measured transmittance.

In the present description, transmittance of, for example, 90% or more in a specific wavelength region means that the transmittance does not fall below 90% in the entire wavelength region, that is, minimum transmittance is 90% or more in the wavelength region. Similarly, transmittance of, for example, 1% or less in a specific wavelength region means that the transmittance does not exceed 1% in the entire wavelength region, that is, maximum transmittance is 1% or less in the wavelength region. The same applies to the internal transmittance. Average transmittance and average internal transmittance in the specific wavelength region are an arithmetic mean of transmittance and internal transmittance per 1 nm in the wavelength region.

Spectral characteristics can be measured by using an ultraviolet-visible spectrophotometer.

In the present description, the symbol “-” or the word “to” that is used to express a numerical range includes the numerical values before and after the symbol or the word as the upper limit and the lower limit of the range, respectively.

### <Optical Filter>

An optical filter according to one embodiment of the present invention (hereinafter, also referred to as “the filter”) includes a light-absorbing material Y₉₀₀₋₁₀₀₀ having a maximum absorption wavelength in a wavelength region of 900 nm to 1,000 nm, and a dielectric multilayer film.

Reflection characteristics of the dielectric multilayer film and absorption characteristics of the light-absorbing material Y₉₀₀₋₁₀₀₀ allow the optical filter as a whole to achieve excellent transmittance in a visible light region and a specific near-infrared light region, and excellent shielding properties in the specific near-infrared light region.

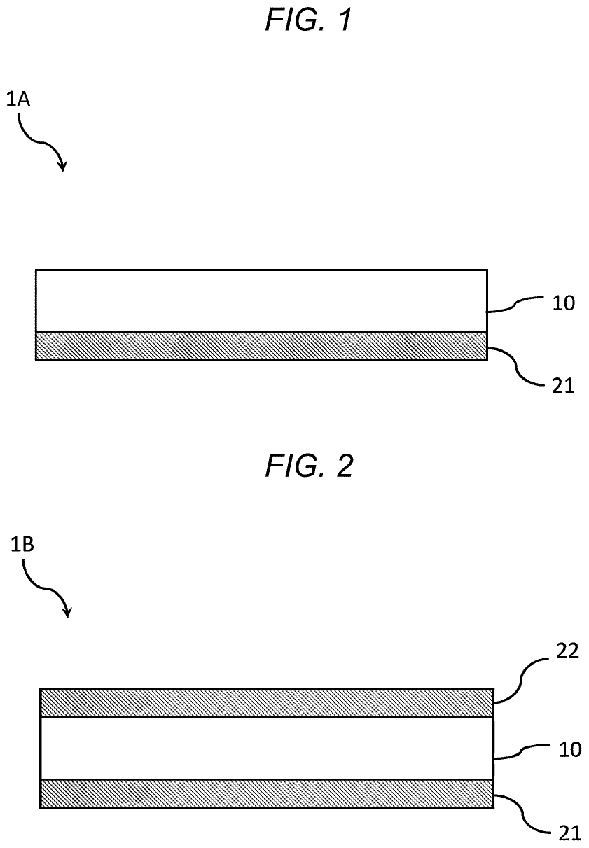

An example of a configuration of the filter will be described with reference to the drawings. FIGS. 1 and 2 are cross-sectional views schematically illustrating examples of the optical filter according to one embodiment.

An optical filter 1A illustrated in FIG. 1 is an example including a support 10 made of the light-absorbing material Y₉₀₀₋₁₀₀₀ and a dielectric multilayer film 21 laminated on one main surface of the support 10.

An optical filter 1B illustrated in FIG. 2 is an example in which a dielectric multilayer film 22 is further provided on a surface of the support 10.

The optical filter according to the present invention satisfies all of the following spectral characteristics (i-1) to (i-6).

(i-1) In a spectral transmittance curve at a wavelength of 450 nm to 600 nm and an incident angle of 0 degrees, an average transmittance T_{450-600(0deg)AVE} is 60% or more.

(i-2) In a spectral transmittance curve at a wavelength of 840 nm to 850 nm and an incident angle of 0 degrees, an average transmittance T_{840-850(0deg)AVE} is 60% or more.

(i-3) In a spectral transmittance curve at a wavelength of 930 nm to 950 nm and an incident angle of 0 degrees, a maximum transmittance T_{930-950(0deg)MAX} is 20% or less.

(i-4) In a spectral transmittance curve at a wavelength of 850 nm to 950 nm,
a wavelength λ_{IRL(0deg)(50%)} at which a transmittance is 50% at an incident angle of 0 degrees and a wavelength λ_{IRL(35deg)(50%)} at which a transmittance is 50% at an incident angle of 35 degrees satisfy the following relational expression:

$$\vert {λ}_{I R L ( 0 deg ) ( 50 \% )} - {λ}_{I R L ( 35 deg ) ( 50 \% )} \vert \leq 15 nm .$$

(i-5) In a spectral reflectance curve at a wavelength of 450 nm to 600 nm and an incident angle of 5 degrees, an average reflectance R_{450-600(5deg)AVE} measured from at least one main surface is 10% or less.

(i-6) In a spectral reflectance curve at a wavelength of 840 nm to 850 nm and an incident angle of 5 degrees, an average reflectance R_{840-850(5deg)AVE} measured from at least one main surface is 10% or less.

The filter satisfying all of the spectral characteristics (i-1) to (i-6) is an optical filter excellent in transmittance of visible light as shown in the characteristic (i-1) and in transmittance of specific near-infrared light as shown in the characteristic (i-2), excellent in shielding properties of the specific near-infrared light as shown in the characteristics (i-3), and excellent in transmission band stability of near-infrared light as shown in the characteristic (i-4). As shown in the characteristics (i-5) and (i-6), the optical filter is excellent in improving transmittance by preventing reflectance in the transmission band of visible light and near-infrared light, and preventing generation of reflected stray light.

Satisfying the spectral characteristic (i-1) means that transmittance in a visible light region of 450 nm to 600 nm is excellent.

T_{450-600(0deg)AVE} is preferably 80% or more, more preferably 88% or more, still more preferably 90% or more, and particularly preferably 95% or more.

In addition, in order to satisfy the spectral characteristic (i-1), for example, a dielectric multilayer film and the light-absorbing material Y₉₀₀₋₁₀₀₀ having excellent transmittance in the visible light region may be used.

Satisfying the spectral characteristic (i-2) means that transmittance in a near-infrared light region of 840 nm to 850 nm is excellent.

T_{840-850(0deg)AVE} is preferably 70% or more, more preferably 80% or more, still more preferably 85% or more, further preferably 90% or more, and particularly preferably 95% or more.

In addition, in order to satisfy the spectral characteristic (i-2), for example, a dielectric multilayer film excellent in the transmittance of the near-infrared light region of 840 nm to 850 nm may be used.

Satisfying the spectral characteristic (i-3) means that shielding properties of a near-infrared light region of 930 nm to 950 nm are excellent.

T_{930-950(0deg)MAX} is preferably 16% or less, more preferably 12% or less, still more preferably 8% or less.

In addition, in order to satisfy the spectral characteristic (i-3), for example, light may be shielded by an absorption ability of the light-absorbing material Y₉₀₀₋₁₀₀₀.

Satisfying the spectral characteristic (i-4) means that a spectral transmittance curve at a wavelength of 850 nm to 950 nm is unlikely to shift even at a high incident angle.

|λ_{IRL(0deg)(50%)}−λ_{IRL(35deg)(50%)}| is preferably 12 nm or less, more preferably 10 nm or less, and still more preferably 8 nm or less.

In order to satisfy the spectral characteristic (i-4), for example, an ytterbium-containing glass to be described later may be used as the light-absorbing material Y₉₀₀₋₁₀₀₀, and light may be shielded by the absorption ability of the light-absorbing material Y₉₀₀₋₁₀₀₀.

Satisfying the spectral characteristic (i-5) means that reflectivity in the visible light region of 450 nm to 600 nm is small.

R_{450-600(5deg)AVE} is preferably 7% or less, and more preferably 5% or less.

Satisfying the spectral characteristic (i-6) means that reflectivity in the near-infrared light region of 840 nm to 850 nm is small.

R_{840-850(5deg)AVE} is preferably 7% or less, and more preferably 5% or less.

In order to satisfy the spectral characteristics (i-5) and (i-6), for example, at least one dielectric multilayer film having small reflectance in the above-mentioned region may be provided.

It is more preferable that the spectral characteristics (i-5) and (i-6) be satisfied on both main surfaces of the optical filter.

The optical filter according to the present invention preferably further satisfies the following spectral characteristic (i-7).

(i-7) In a spectral transmittance curve at a wavelength of 850 nm to 950 nm and an incident angle of 0 degrees,
a wavelength λ_{IRL(0deg)(55%)} at which a transmittance is 55% and a wavelength λ_{IRL(0deg)(45%)} at which a transmittance is 45% satisfy the following relational expression:

$$\vert 10 / [ {λ}_{IRL ( 0 deg ) ( 45 \% )} - {λ}_{IRL ( 0 deg ) ( 55 \% )} ] \vert \geq 1.5 .$$

The above-mentioned relational expression in the spectral characteristic (i-7) means a degree of fall of a spectral transmittance curve (an inclination of a cutoff of a near-infrared band) which is switched from a near-infrared light region around 850 nm to be transmitted to a near-infrared light region around 950 nm to be shielded. From the viewpoint of efficiently capturing light, the steeper the spectral curve in a boundary region between a transmission region and a shielding region is, the more ideal. It means that when the above-mentioned relational expression (inclination) in the spectral characteristic (i-7) is 1.5 or more, transmittance of near-infrared light to be transmitted is excellent.

The above-mentioned relational expression (inclination) in the spectral characteristic (i-7) is more preferably 1.6 or more, and still more preferably 1.7 or more.

In order to satisfy in order to satisfy the spectral characteristic (i-7), for example, the ytterbium-containing glass to be described later may be used as the light-absorbing material Y₉₀₀₋₁₀₀₀, and light may be shielded by the absorption ability of the light-absorbing material Y₉₀₀₋₁₀₀₀.

The optical filter according to the present invention preferably further satisfies the following spectral characteristics (i-8) and (i-9).

(i-8) In a spectral reflectance curve at a wavelength of 450 nm to 600 nm and an incident angle of 35 degrees, an average reflectance R_{450-600(35deg)AVE} measured from at least one main surface is 10% or less.

(i-9) In a spectral reflectance curve at a wavelength of 840 nm to 850 nm and an incident angle of 35 degrees, an average reflectance R_{840-850(35deg)AVE} measured from at least one main surface is 10% or less.

Satisfying the spectral characteristic (i-8) means that the reflectivity in the visible light region of 450 nm to 600 nm is small even at a high incident angle.

R_{450-600(35deg)AVE} is preferably 7% or less, and more preferably 5% or less.

Satisfying the spectral characteristic (i-9) means that the reflectivity in the near-infrared light region of 840 nm to 850 nm is small even at a high incident angle.

R_{840-850(35deg)AVE} is preferably 7% or less, and more preferably 5% or less.

The optical filter according to the present invention preferably further satisfies the following spectral characteristic (i-10).

(i-10) In a spectral reflectance curve at a wavelength of 930 nm to 1,000 nm and an incident angle of 5 degrees, an average reflectance R_{930-1000(5deg)AVE} measured from at least one main surface is 5% or more.

Satisfying the spectral characteristic (i-10) means reflecting light in a near-infrared light region of 930 nm to 1,000 nm.

R_{930-1000(5deg)AVE} is preferably 20% or more, more preferably 30% or more, and still more preferably 40% or more.

In order to satisfy the spectral characteristic (i-10), for example, at least one dielectric multilayer film having large reflectance in the above-mentioned region may be provided.

The optical filter according to the present invention preferably further satisfies the following spectral characteristic (i-11).

(i-11) In a spectral reflectance curve at a wavelength of 1,000 nm to 1,100 nm and an incident angle of 5 degrees, an average reflectance R_{1000-1100(5deg)AVE} measured from at least one main surface is 5% or more.

Satisfying the spectral characteristic (i-11) means reflecting light in a near-infrared light region of 1,000 nm to 1,100 nm.

R_{1000-1100(5deg)AVE} is preferably 40% or more, and more preferably 70% or more.

In order to satisfy the spectral characteristic (i-11), for example, at least one dielectric multilayer film having large reflectance in the above-mentioned region may be provided.

The optical filter according to the present invention preferably further satisfies the following spectral characteristic (i-12).

(i-12) In a spectral transmittance curve at a wavelength of 600 nm to 700 nm and an incident angle of 0 degrees, an average transmittance T_{600-700(0deg)AVE} is 60% or more.

Satisfying the spectral characteristic (i-12) means that transmittance is excellent even in a region of 600 nm to 700 nm, that is, a red band region between the visible light region and the transmission region around 850 nm.

T_{600-700(0deg)AVE} is preferably 70% or more, more preferably 80% or more, still more preferably 85% or more, further preferably 90% or more, and particularly preferably 95% or more.

In addition, in order to satisfy the spectral characteristic (i-12), for example, a dielectric multilayer film excellent in transmittance of the region of 600 nm to 700 nm may be used.

### <Light-Absorbing Material Y₉₀₀₋₁₀₀₀>

The filter includes a light-absorbing material Y₉₀₀₋₁₀₀₀ having a maximum absorption wavelength in a wavelength region of 900 nm to 1,000 nm. Accordingly, it is possible to compensate for light shielding properties of a region where light is not shielded by the reflection characteristics of the dielectric multilayer film.

The light-absorbing material Y₉₀₀₋₁₀₀₀ preferably satisfies the following spectral characteristic (iii-1).

(iii-1) An average optical density OD_{940-960_AVE} at a wavelength of 940 nm to 960 nm/an average optical density OD_{840-860 AVE} at a wavelength of 840 nm to 860 nm>5.

A ratio of the spectral characteristic (iii-1) increases as an average transmittance at the wavelength of 840 nm to 860 nm increases and an average transmittance at the wavelength of 940 nm to 960 nm decreases. When the ratio of the spectral characteristic (iii-1) is larger than 5, it means that the light-absorbing material Y₉₀₀₋₁₀₀₀ sufficiently transmits near-infrared light of the wavelength of 840 nm to 860 nm and sufficiently absorbs near-infrared light of the wavelength of 940 nm to 960 nm. The ratio of the spectral characteristic (iii-1) is more preferably 10 or more, and still more preferably 20 or more.

The light-absorbing material Y₉₀₀₋₁₀₀₀ preferably further satisfies the following spectral characteristic (iii-2).

(iii-2) An average optical density OD_{920-930_AVE} at a wavelength of 920 nm to 930 nm/an average optical density OD_{870-880_AVE} at a wavelength of 870 nm to 880 nm>3.

A ratio of the spectral characteristic (iii-2) is more preferably 5 or more, and still more preferably 7 or more.

The light-absorbing material Y₉₀₀₋₁₀₀₀ is not limited as long as it is a material capable of obtaining the above-mentioned spectral characteristic, and for example, an inorganic material containing ytterbium is preferable, and a single crystal and a polycrystalline sintered body such as Yb₂O₃, Yb:YAG (Yttrium Aluminum Garnet), Yb:YVO₄, and the like, a glass containing ytterbium, or the like is considered. Among those, a glass containing ytterbium is more preferable from the viewpoint of processability, stability of material quality, and ease of adjusting physical properties. When the light-absorbing material Y₉₀₀₋₁₀₀₀ is such a material, the spectral characteristics (iii-1) and (iii-2) are easily satisfied.

The ytterbium-containing glass preferably has a maximum absorption wavelength of 940 nm to 1,000 nm.

In the ytterbium-containing glass, an average internal transmittance at a wavelength of 450 nm to 600 nm and an incident angle of 0 degrees is preferably 60% or more, more preferably 80% or more, and still more preferably 90% or more.

In the ytterbium-containing glass, an average internal transmittance at a wavelength of 700 nm to 800 nm and an incident angle of 0 degrees is preferably 60% or more, more preferably 80% or more, and still more preferably 90% or more.

The ytterbium-containing glass is excellent in transmittance in the visible light region and transmittance in a region from visible light to near-infrared light of about 800 nm, and in particular absorbs near-infrared light of 900 nm to 1,000 nm. In addition, since light is shielded by the absorption characteristic, light shielding properties are not affected by the incident angle unlike the dielectric multilayer film. Therefore, by using the ytterbium-containing glass, when the sensing wavelength region is particularly 800 nm to 900 nm, an optical filter is obtained in which transmittance in the near-infrared light region is excellent even at a high incident angle, a spectral transmittance curve of a boundary region between such a transmission region and a wavelength region of 900 nm or more to be shielded is hardly shifted depending on an incident angle, and which is hardly affected by the incident angle.

Examples of the ytterbium-containing glass include a glass having any of the following compositions.

(1) Glass containing Yb₂O₃ and B₂O₃ as essential components in terms of mol % based on an oxide, in which a content of Yb₂O₃ is 10 mol % to 60 mol %, and a content of B₂O₃ is 10 mol % to 70 mol %.

(2) Glass further containing SiO₂ as an essential component in addition to (1), in which a content of SiO₂ is 5 mol % to 35 mol %.

(3) Glass further containing La₂O₃ as an essential component in addition to (1) and (2), in which a content of La₂O₃ is 1 mol % to 20 mol %.

As the ytterbium-containing glass, a commercially available product may be used, and the ytterbium-containing glass can be manufactured by known methods disclosed in Japanese Laid-Open Patent Publication No. S61-163138, Japanese Laid-Open Patent Publication No. S56-78447, and the like.

In addition, as the ytterbium-containing glass, there may be used chemically strengthened glass obtained by exchanging, in glass having a composition containing an alkali metal, alkali metal ions (for example, Li ions and Na ions) having a small ionic radius present on a main surface of a glass plate with alkali ions having a larger ionic radius (for example, Na ions or K ions with respect to Li ions and K ions with respect to Na ions) by ion exchange at a temperature equal to or lower than a glass transition point.

The light-absorbing material Y₉₀₀₋₁₀₀₀ preferably has a plate shape, and has a thickness of preferably 3 mm or less, more preferably 2 mm or less, and still more preferably 1 mm or less from the viewpoint of ease of optical design when incorporated into a camera module, and the thickness is preferably 0.1 mm or more from the viewpoint of device strength and a necessity of obtaining desired optical characteristics.

### <Dielectric Multilayer Film>

The filter includes a dielectric multilayer film. The filter may have one or more dielectric multilayer films, at least one of which is preferably designed as a reflective film (hereinafter, also referred to as an “NIR reflective film”) that reflects a part of near-infrared light. Other dielectric multilayer films may be designed as a reflection layer having a reflection region other than a near-infrared region, or an antireflection layer.

The NIR reflection layer has, for example, wavelength selectivity of transmitting visible light, transmitting near-infrared light in a transmission region of the absorption layer, and mainly reflecting other near-infrared light. The NIR reflection layer may be further appropriately designed to have a specification further reflecting light in a wavelength range other than the near-infrared light, for example, near ultraviolet light.

As a dielectric multilayer film when designed as the NIR reflection layer, it is preferable that the following spectral characteristics be satisfied.

(iv-1) With the dielectric multilayer film designed as the NIR reflection layer being used as a plane of incidence, an average reflectance R_{D_450-600AVE} in a spectral reflectance curve at a wavelength of 450 nm to 600 nm and an incident angle of 5 degrees of the optical filter is 3% or less.

(iv-2) With the dielectric multilayer film designed as the NIR reflection layer being used as a plane of incidence, an average reflectance R_{D_1000-1200AVE} in a spectral reflectance curve at a wavelength of 1,000 nm to 1,200 nm and an incident angle of 5 degrees of the optical filter is 40% or more.

A part of the near-infrared light region of 700 nm to 1,000 nm needs to have a certain degree of transmittance according to a sensing wavelength region of an element on which the optical filter is mounted. In consideration of the reflection characteristics of the dielectric multilayer film and the absorption characteristics of the absorbing material, the reflection characteristics of the dielectric multilayer film can be appropriately designed so as to achieve target transmittance for the entire optical filter.

As a dielectric multilayer film when designed as the NIR reflection layer, it is preferable that the following spectral characteristics be further satisfied.

(iv-3) With the dielectric multilayer film designed as the NIR reflection layer being used as a plane of incidence, an average reflectance R_{D_600-700AVE} in a spectral reflectance curve at a wavelength of 600 nm to 700 nm and an incident angle of 5 degrees of the optical filter is 3% or less.

(iv-4) With the dielectric multilayer film designed as the NIR reflection layer being used as a plane of incidence, an average reflectance R_{D_840-850AVE} in a spectral reflectance curve at a wavelength of 840 nm to 850 nm and an incident angle of 5 degrees of the optical filter is 3% or less.

The NIR reflection layer includes, for example, a dielectric multilayer film in which dielectric films having a low refractive index (low refractive index films) and dielectric films having a high refractive index (high refractive index films) are alternately laminated. The high refractive index film preferably has a refractive index of 1.6 or more, and more preferably 2.2 to 2.5. Examples of a material of the high refractive index film include Ta₂O₅, TiO₂, and Nb₂O₅. Among those, TiO₂ is preferable from the viewpoint of reproducibility in film formability and refractive index, stability, and the like.

On the other hand, the low refractive index film preferably has a refractive index of less than 1.6, and more preferably 1.45 or more and less than 1.55. Examples of a material of the low refractive index film include SiO₂ and SiOₓN_{y}. SiO₂ is preferable from the viewpoint of reproducibility in film formability, stability, economic efficiency, and the like.

In order for the NIR reflection layer to transmit visible light and specific near-infrared light, several kinds of dielectric multilayer films having different spectral characteristics may be combined when transmitting and selecting a desired wavelength band.

For example, adjustment can be made according to a material constituting the film, a film thickness of each layer, and the number of layers.

In the NIR reflection layer, the total number of laminated layers of the dielectric multilayer films constituting the reflection layer is preferably 20 or more, and more preferably 25 or more from the viewpoint of controlling a wavelength band subjected to transmission and light shielding, and is preferably 60 or less from the viewpoint of preventing a ripple.

The film thickness of the dielectric multilayer film is preferably 100 nm or more, and more preferably 300 nm or more from the viewpoint of preventing deterioration of the absorbing material, and is preferably 5 μm or less from the viewpoint of productivity and prevention of a reflection ripple in the visible light region.

For formation of the dielectric multilayer film, for example, a vacuum film formation process such as a CVD method, a sputtering method, or a vacuum deposition method, a wet film formation process such as a spraying method or a dipping method, or the like can be used.

The NIR reflection layer may provide predetermined optical characteristics by one layer (one group of dielectric multilayer films) or may provide the predetermined optical characteristics by two layers. When two or more NIR reflection layers are provided, the respective reflection layers may have the same configuration or different configurations. In the case where two or more reflection layers are provided, generally the NIR reflection layer may be formed of a plurality of reflection layers having different reflection bands. In a case where two reflection layers are provided, one of the reflection layers may be a near-infrared reflection layer that shields light in a short wavelength band in the near-infrared region, and the other of the reflection layers may be a near-infrared and near ultraviolet reflection layer that shields light in both a long wavelength band of the near-infrared region and a near ultraviolet region.

The other dielectric multilayer films may be designed as an antireflection layer. Examples of the antireflection layer include a dielectric multilayer film, an intermediate refractive index medium, and a moth-eye structure in which the refractive index gradually changes. Among those, the dielectric multilayer film is preferable from the viewpoint of optical efficiency and productivity. The antireflection layer is obtained by alternately laminating a dielectric film having a high refractive index and a dielectric film having a low refractive index similarly to the reflection layer.

The filter may further include a near-infrared ray absorbing dye (NIR dye) or an ultraviolet absorbing dye (UV dye) in order to compensate for the light shielding properties in a specific wavelength region. In this case, for example, an absorption layer including the above-mentioned dye and a transparent resin is preferably provided.

The filter may include, as another component, for example, a component (layer) that provides absorption by inorganic fine particles or the like that control transmission and absorption of light in a specific wavelength region. Specific examples of the inorganic fine particles include indium tin oxides (ITO), antimony-doped tin oxides (ATO), cesium tungstate, and lanthanum boride. The ITO fine particles and the cesium tungstate fine particles have high visible light transmittance and have light absorbing properties in a wide range of an infrared wavelength region exceeding 1,200 nm, and thus can be used in a case where shielding properties of infrared light are required.

### <Imaging Device>

The imaging device according to the present invention preferably includes the optical filter according to the present invention. The imaging device preferably further includes a solid state image sensor and an imaging lens. By providing the filter which is excellent in transmittance of visible light and specific near-infrared light and has shielding properties of specific near-infrared light, it is possible to obtain an imaging device excellent in color reproducibility even for light at a high incident angle.

In addition, the optical filter according to the present invention can also be used in combination with a band pass filter that transmits visible light and specific near-infrared light. In this case, the imaging device according to the present invention preferably includes the optical filter according to the present invention, and a band pass filter including a visible light transmission band including a wavelength region of 450 nm to 650 nm and a near-infrared light transmission band including a wavelength region of 840 nm to 850 nm. For example, in the spectral characteristics of the band pass filter, by combining the optical filter according to the present invention with a band pass filter having low incident angle dependence at a visible light transmission band and at a transmission and shielding switching cutoff end on a short wavelength side of a near-infrared light transmission band around 850 nm, it is possible to prevent the incident angle dependence of both the visible light transmission band and the near-infrared light transmission band around 850 nm. Since the optical filter according to the present invention has high transmittance in the visible light band and around 850 nm, a function of low incident angle dependence can be added without greatly impairing transmission characteristics of the band pass filter. In this case, the optical filter according to the present invention may be mounted between a lens and a sensor in the imaging device together with a band pass filter to be combined, or may be mounted between a plurality of lenses. Further, for example, when the light-absorbing material Y₉₀₀₋₁₀₀₀ of the filter is a glass plate having a thickness of more than 1 mm, the optical filter may be mounted on an outermost surface of a camera module, or may be mounted outside the lens or separately from the camera module with a function as a cover glass. When the filter is mounted between lenses or between a sensor and a lens, there are many restrictions on optical design, but in a case where the filter is mounted on the outermost surface of a camera module or outside the lens as a cover glass, the design flexibility can be increased.

As described above, the present invention relates to the following optical filter and the like.

[1] An optical filter including:
a light-absorbing material Y₉₀₀₋₁₀₀₀ having a maximum absorption wavelength in a wavelength region of 900 nm to 1,000 nm, and
a dielectric multilayer film, in which
the optical filter satisfies all of the following spectral characteristics (i-1) to (i-6).

(i-1) In a spectral transmittance curve at a wavelength of 450 nm to 600 nm and an incident angle of 0 degrees, an average transmittance T_{450-600(0deg)AVE} is 60% or more.

(i-2) In a spectral transmittance curve at a wavelength of 840 nm to 850 nm and an incident angle of 0 degrees, an average transmittance T_{840-850(0deg)AVE} is 60% or more.

(i-3) In a spectral transmittance curve at a wavelength of 930 nm to 950 nm and an incident angle of 0 degrees, a maximum transmittance T_{930-950(0deg)MAX} is 20% or less.

(i-4) In a spectral transmittance curve at a wavelength of 850 nm to 950 nm,
a wavelength λ_{IRL(0deg)(50%)} at which a transmittance is 50% at an incident angle of 0 degrees and a wavelength λ_{IRL(35deg)(50%)} at which a transmittance is 50% at an incident angle of 35 degrees satisfy the following relational expression:

$$\vert {λ}_{I R L ( 0 deg ) ( 50 \% )} - {λ}_{I R L ( 35 deg ) ( 50 \% )} \vert \leq 15 nm .$$

(i-5) In a spectral reflectance curve at a wavelength of 450 nm to 600 nm and an incident angle of 5 degrees, an average reflectance R_{450-600(5deg)AVE} measured from at least one main surface is 10% or less.

(i-6) In a spectral reflectance curve at a wavelength of 840 nm to 850 nm and an incident angle of 5 degrees, an average reflectance R_{840-850(5deg)AVE} measured from at least one main surface is 10% or less.

[2] The optical filter according to [1], in which the optical filter further satisfies the following spectral characteristic (i-7).

(i-7) In a spectral transmittance curve at a wavelength of 850 nm to 950 nm and an incident angle of 0 degrees,
a wavelength λ_{IRL(0deg)(55%)} at which a transmittance is 55% and a wavelength λ_{IRL(0deg)(45%)} at which a transmittance is 45% satisfy the following relational expression:

$$\vert 10 / [ {λ}_{IRL ( 0 deg ) ( 45 \% )} - {λ}_{IRL ( 0 deg ) ( 55 \% )} ] \vert \geq 1.5 .$$

[3] The optical filter according to [1] or [2], in which the optical filter further satisfies the following spectral characteristics (i-8) and (i-9).

(i-8) In a spectral reflectance curve at a wavelength of 450 nm to 600 nm and an incident angle of 35 degrees, an average reflectance R_{450-600(35deg)AVE} measured from at least one main surface is 10% or less.

(i-9) In a spectral reflectance curve at a wavelength of 840 nm to 850 nm and an incident angle of 35 degrees, an average reflectance R_{840-850(35deg)AVE} measured from at least one main surface is 10% or less.

[4] The optical filter according to any of [1] to [3], in which the optical filter further satisfies the following spectral characteristic (i-10).

(i-10) In a spectral reflectance curve at a wavelength of 930 nm to 1,000 nm and an incident angle of 5 degrees, an average reflectance R_{930-1000(5deg)AVE} measured from at least one main surface is 5% or more.

[5] The optical filter according to any of [1] to [4], in which the optical filter further satisfies the following spectral characteristic (i-11).

(i-11) In a spectral reflectance curve at a wavelength of 1,000 nm to 1,100 nm and an incident angle of 5 degrees, an average reflectance R_{1000-1100(5deg)AVE} measured from at least one main surface is 5% or more.

[6] The optical filter according to any of [1] to [5], in which the light-absorbing material Y₉₀₀₋₁₀₀₀ has a plate shape having a thickness of 3 mm or less.

[7] The optical filter according to any of [1] to [6], in which the light-absorbing material Y₉₀₀₋₁₀₀₀ satisfies the following spectral characteristic (iii-1).

(iii-1) An average optical density OD_{940-960_AVE} at a wavelength of 940 nm to 960 nm/an average optical density OD_{840-860_AVE} at a wavelength of 840 nm to 860 nm>5.

[8] The optical filter according to any of [1] to [7], in which the light-absorbing material Y₉₀₀₋₁₀₀₀ satisfies the following spectral characteristic (iii-2).

(iii-2) An average optical density OD_{920-930_AVE} at a wavelength of 920 nm to 930 nm/an average optical density OD_{870-880_AVE} at a wavelength of 870 nm to 880 nm>3.

[9] An imaging device including the optical filter according to any of [1] to [8].

[10] An imaging device including:
the optical filter according to any of [1] to [8]; and
a band pass filter including a visible light transmission band including a wavelength region of 450 nm to 650 nm and a near-infrared light transmission band including a wavelength region of 840 nm to 850 nm.

### EXAMPLES

Next, the present invention will be described more specifically with reference to examples.

For measurement of each spectral characteristic, an ultraviolet-visible spectrophotometer (UH-4150 type, manufactured by Hitachi High-Tech Corporation) was used.

The spectral characteristic in a case where an incident angle is not particularly specified is a value measured at an incident angle of 0 degrees (in a direction perpendicular to a main surface of an optical filter).

Dyes used in respective examples are as follows.

Compound 1 (merocyanine compound): synthesized based on the description of German Patent No. 10109243.

Compound 2 (squarylium compound): synthesized based on JP2020-31198A.

The compound 1 is a near ultraviolet absorbing dye (UV dye), and the compound 2 is a near-infrared ray absorbing dye (NIR dye).

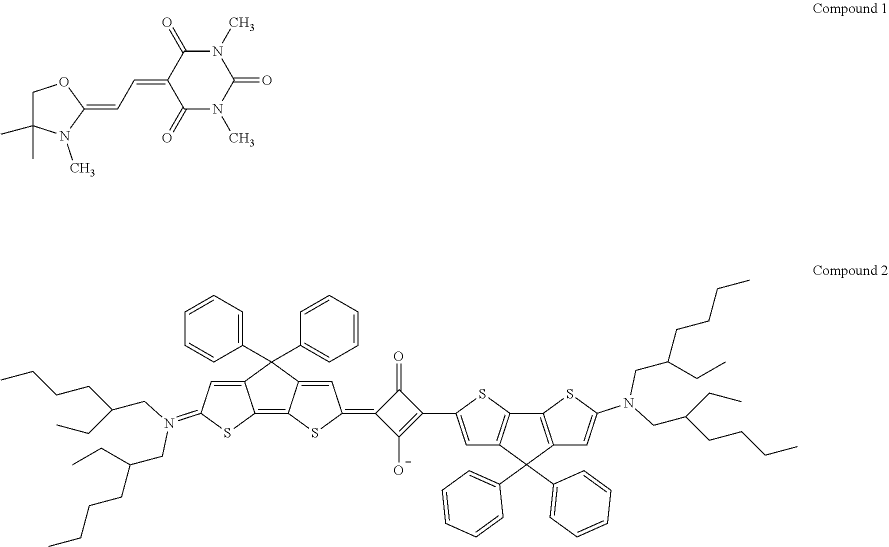

### <Spectral Characteristics of Dye>

Each of the above-mentioned dyes (compounds 1 and 2) is dissolved in a polyimide resin C-3G30G manufactured by Mitsubishi Gas Chemical Company, Inc. and a maximum absorption wavelength in a measured absorption spectrum is shown.

TABLE 1

| | Maximum absorption |
|---|---|
| Pigment | wavelength (in resin) |
| Compound 1 | 397 nm |
| Compound 2 | 929 nm |

### <Spectral Characteristics of Near-Infrared Ray Absorbing Glass (Light-Absorbing Material Y₉₀₀₋₁₀₀₀)>

As the near-infrared ray absorbing glass, a ytterbium (Yb)-containing glass having a composition shown in the following table was manufactured with reference to Japanese Laid-Open Patent Publication No. S61-163138 and Japanese Laid-Open Patent Publication No. S56-78447.

TABLE 2

| | | Near-infrared ray absorbing glass | | | |
|---|---|---|---|---|---|
| | | Yb-containing | Yb-containing | Yb-containing | Yb-containing |
| | Type | glass 1 | glass 2 | glass 3 | glass 4 |
| Glass | Thickness | 1.25 mm | 1.25 mm | 0.8 mm | 0.56 mm |
| Glass | SiO₂ | 32.90 | — | — | 7.5 |
| composition | B₂O₃ | 23.20 | 63.00 | 63.00 | 23.6 |
| (mol %) | Al₂O₃ | — | 8.10 | 8.10 | — |
| | P₂O₅ | — | — | — | 7.5 |
| | ZnO | — | 6.70 | 6.70 | — |
| | BaO | — | 1.80 | 1.80 | — |
| | ZrO₂ | 7.30 | — | — | — |
| | La₂O₃ | 13.80 | 5.10 | 5.10 | — |
| | Ga₂O₃ | — | — | — | 14.2 |
| | Yb₂O₃ | 22.80 | 15.30 | 15.30 | 47.2 |

A spectral transmittance curve and a spectral reflectance curve in a wavelength range of 350 nm to 1,200 nm were measured with respect to the near-infrared ray absorbing glass (ytterbium-containing glass) and a non-absorbing glass (alkali glass, D263, 0.2 mm, manufactured by SCHOTT) using the ultraviolet-visible spectrophotometer, and an optical density was calculated based on an obtained transmittance.

Results are shown in the following table 3. The spectral characteristics shown in the following table were evaluated in terms of internal transmittance in order to avoid an influence of reflection at an air interface and a glass interface.

Internal transmittance (%)={measured transmittance_{(0deg)}/(100−reflectance_{(5deg)}}×100

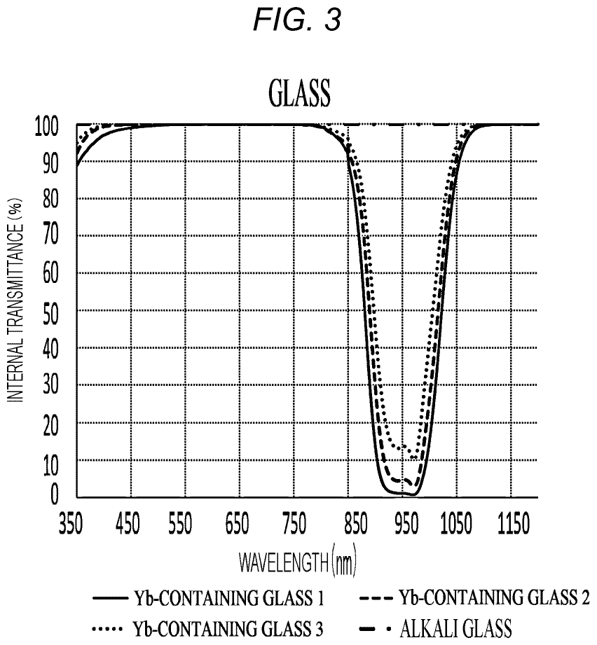

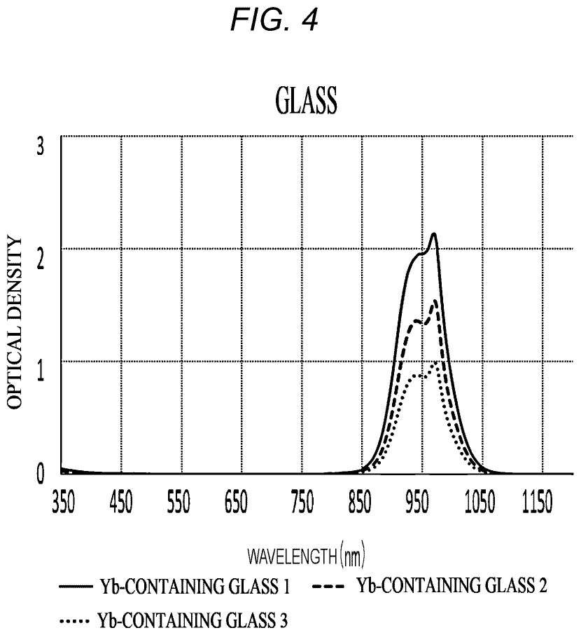

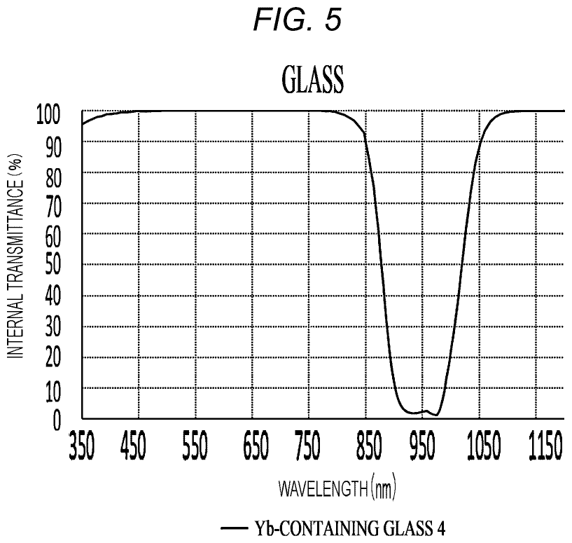

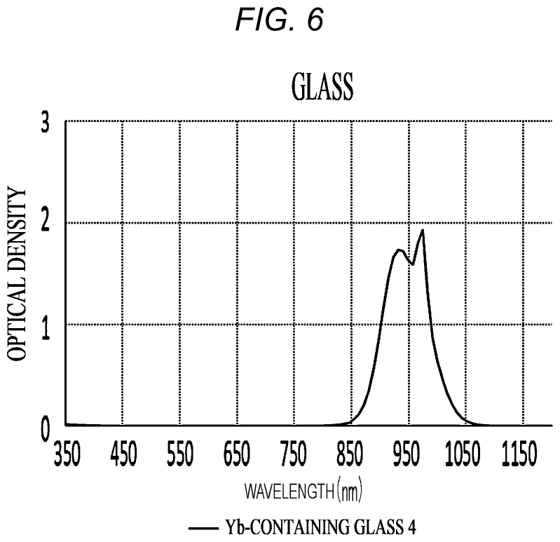

In addition, spectral transmittance curves of the Yb-containing glasses 1 to 3 and the alkali glass are shown in FIG. 3, optical density curves of the Yb-containing glasses 1 to 3 are shown in FIG. 4, a spectral transmittance curve of the Yb-containing glass 4 is shown in FIG. 5, and an optical density curve of the Yb-containing glass 4 is shown in FIG. 6.

TABLE 3

| | | | | | | Non- |
|---|---|---|---|---|---|---|
| | | | | | | absorbing |
| | | Near-infrared ray absorbing glass | | | | glass |
| Glass | Glass material type | Yb- | Yb- | Yb- | Yb- | Alkali |
| | | containing | containing | containing | containing | glass |
| | | glass 1 | glass 2 | glass 3 | glass 4 | |
| | Thickness | 1.25 mm | 1.25 mm | 0.8 mm | 0.56 mm | 0.2 mm |
| Spectral | OD_940-960_AVE/OD_840- | 40.22 | 39.70 | 40.02 | 32.4 | — |
| characteristics | 860_AVE | | | | | |
| | OD_920-930_AVE/OD_870- | 8.07 | 9.21 | 9.23 | 6.4 | — |
| | 880_AVE | | | | | |
| | Maximum absorption | 970 | 971 | 971 | 975 | — |
| | wavelength (nm) | | | | | |

### <Spectral Characteristics of Near-Infrared Ray Absorbing Ceramics (Light-Absorbing Material Y₉₀₀₋₁₀₀₀)>

As the near-infrared ray absorbing ceramics, 10% Yb:YAG ceramics (manufactured by Konoshima Chemical Co., Ltd.) and 5% Yb:YAG ceramics (manufactured by Konoshima Chemical Co., Ltd.), which are polycrystalline sintered bodies containing ytterbium, were prepared. Here, “%” refers to a doping amount of Yb, that is, a composition ratio of Yb to an element to be replaced by Yb in a base material and Yb, and a unit thereof is at %. In the case of YAG, Y in Y₃Al₅O₁₂ is replaced by Yb, and thus “%” indicates a value of [Yb/(Yb+Y)]×100.

A spectral transmittance curve and a spectral reflectance curve in a wavelength range of 350 nm to 1,200 nm were measured with respect to the near-infrared ray absorbing ceramics (Yb:YAG ceramics) using the ultraviolet-visible spectrophotometer, and an optical density was calculated based on an obtained transmittance.

Results are shown in the following table. Spectral characteristics shown in the following table 4 were evaluated in terms of internal transmittance in order to avoid an influence of reflection at an air interface and a ceramics interface.

$$Internal transmittance ( \% ) = \{ measured {transmittance}_{( 0 deg )} / ( 100 - {reflectance}_{( 5 deg )} ) \} \times 100$$

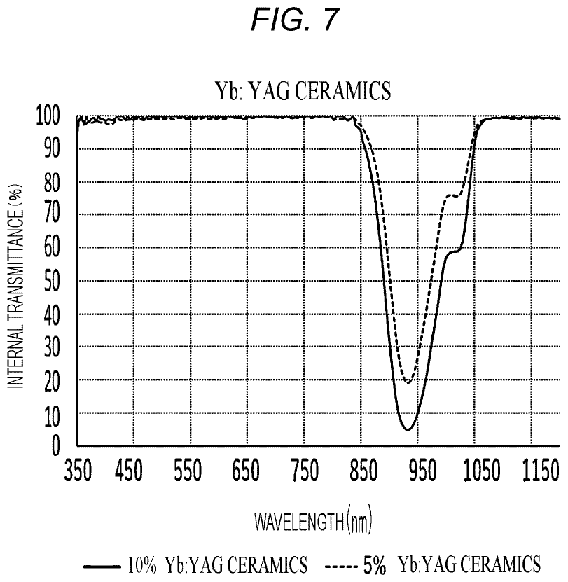

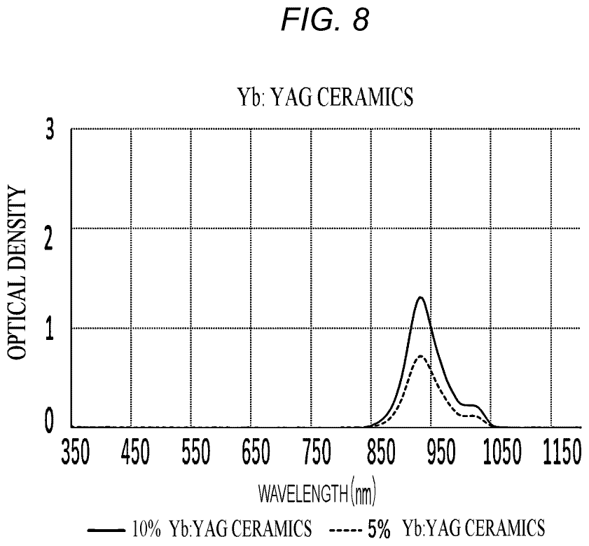

FIG. 7 illustrates spectral transmittance curves of the 10% Yb:YAG ceramics and the 5% Yb:YAG ceramics, and FIG. 8 illustrates optical density curves of the 10% Yb:YAG ceramics and the 5% Yb:YAG ceramics.

TABLE 4

| | | Near-infrared ray absorbing ceramics | |
|---|---|---|---|
| | | 10% Yb: | 5% Yb: |
| | Glass material type | YAG ceramics | YAG ceramics |
| Ceramics | Thickness | 6 mm | 6 mm |
| Spectral | OD_940-960_AVE/OD_840- | 46.0 | 49.6 |
| | 860_AVE | | |
| characteristics | OD_920-930_AVE/OD_870- | 9.7 | 10.2 |
| | 880_AVE | | |
| | Maximum absorption wavelength | 931 | 931 |
| | (nm) | | |

### <Spectral Characteristics of Absorption Layer>

The dyes of the compounds 1 and 2 were mixed with a polyimide resin solution prepared in the same manner as in calculation of the spectral characteristics of the above-mentioned compounds at a concentration shown in the following table, and stirred and dissolved at 50° C. for 2 hours to obtain a coating solution. The obtained coating solution was applied onto an alkali glass (D263 glass, thickness: 0.2 mm, manufactured by SCHOTT) by a spin coating method to form an absorption layer having a film thickness shown in the following table.

With respect to the obtained absorption layer, a spectral transmittance curve and a spectral reflectance curve in a wavelength range of 350 nm to 1,200 nm were measured using the ultraviolet-visible spectrophotometer.

Results are shown in the following table.

The spectral characteristics shown in the following table were evaluated in terms of internal transmittance in order to avoid an influence of reflection at an air interface and a glass interface.

$$Internal transmittance ( \% ) = \{ measured {transmittance}_{( 0 deg )} / ( 100 - {reflectance}_{( 5 deg )} ) \} \times 100$$

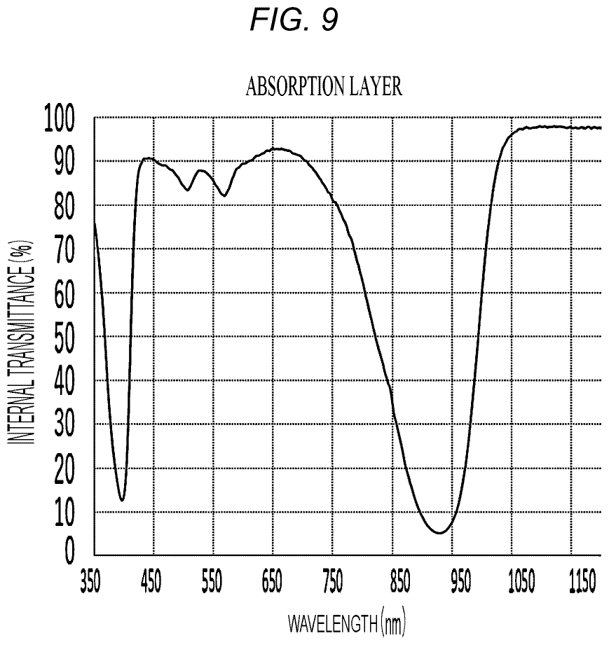

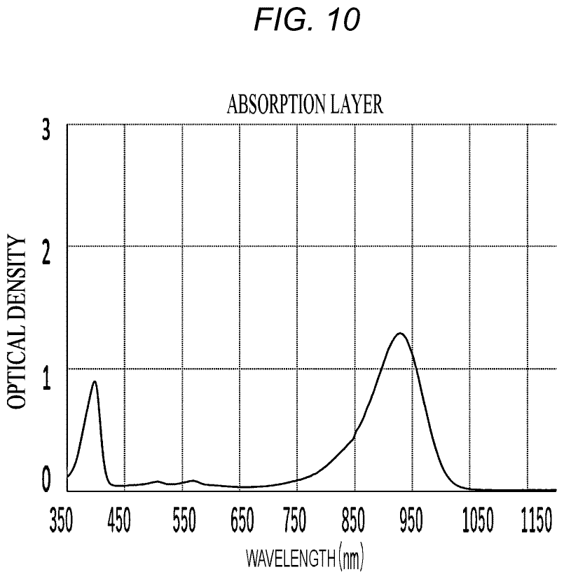

FIG. 9 illustrates a spectral transmittance curve of the absorption layer, and FIG. 10 illustrates an optical density curve of the absorption layer.

TABLE 5
Absorption layer

| Film thickness of absorption layer (μm) | | 1 |
|---|---|---|
| Added amount of | Compound 1 (λMAX: 397 nm) | 3.6 |
| pigment (mass %) | Compound 2 (λMAX: 929 nm) | 7.8 |
| Spectral characteristics | OD_940-960_AVE/OD_840-860_AVE | 2.65 |
| | OD_920-930_AVE/OD_870-880_AVE | 1.77 |

### Example 1-1: Spectral Characteristics of Optical Filter

A first dielectric multilayer film (reflective film) was formed by alternately laminating SiO₂ and TiO₂ on one surface of infrared ray absorbing glass (Yb-containing glass 1) by vapor deposition.

A second dielectric multilayer film (antireflection film) was formed by alternately laminating SiO₂ and TiO₂ on a surface of the first dielectric multilayer film (reflective film) by vapor deposition.

Thus, an optical filter 1-1 was manufactured.

### Example 1-2

An optical filter 1-2 was manufactured in the same manner as in Example 1-1 except that the infrared ray absorbing glass was changed from the Yb-containing glass 1 to the Yb-containing glass 2.

### Example 1-3

An optical filter 1-3 was manufactured in the same manner as in Example 1-1 except that the infrared ray absorbing glass was changed from the Yb-containing glass 1 to the Yb-containing glass 3.

### Example 1-4

An optical filter 1-4 was manufactured in the same manner as in Example 1-1 except that the infrared ray absorbing glass (Yb-containing glass 1) was changed to a non-absorbing glass (alkali glass, D263, 0.2 mm, manufactured by SCHOTT).

### Example 1-5

A first dielectric multilayer film (reflective film) was formed by alternately laminating SiO₂ and TiO₂ on one surface of a non-absorbing glass (alkali glass, D263, 0.2 mm, manufactured by SCHOTT) by vapor deposition.

A resin solution was applied to a surface of the first dielectric multilayer film with the same composition as that of the above-mentioned absorption layer, and an organic solvent was removed by sufficiently heating to form an absorption layer having a thickness of 1 μm.

A second dielectric multilayer film (antireflection film) was formed by alternately laminating SiO₂ and TiO₂ on a surface of the absorption layer by vapor deposition.

Thus, an optical filter 1-5 was manufactured.

### Example 1-6

An optical filter 1-6 was manufactured in the same manner as in Example 1-1 except that the infrared ray absorbing glass was changed from the Yb-containing glass 1 to the Yb-containing glass 4.

### Example 1-7

An optical filter 1-7 was manufactured in the same manner as in Example 1-1 except that the light-absorbing material Y₉₀₀₋₁₀₀₀ was changed from the Yb-containing glass 1 to the 10% Yb:YAG ceramics.

### Example 1-8

An optical filter 1-8 was manufactured in the same manner as in Example 1-1 except that the light-absorbing material Y₉₀₀₋₁₀₀₀ was changed from the Yb-containing glass 1 to the 5% Yb:YAG ceramics.

Reflectance of the first dielectric multilayer film in each of the above-mentioned optical filters is shown in the following table.

With respect to each of the optical filters obtained as described above, spectral transmittance curves at an incident angle of 0 degrees and an incident angle of 35 degrees and a spectral reflectance curve at an incident angle of 5 degrees in a wavelength range of 350 nm to 1,200 nm were measured using the ultraviolet-visible spectrophotometer.

Respective characteristics shown in the following tables were calculated based on the obtained data of the spectral characteristics.

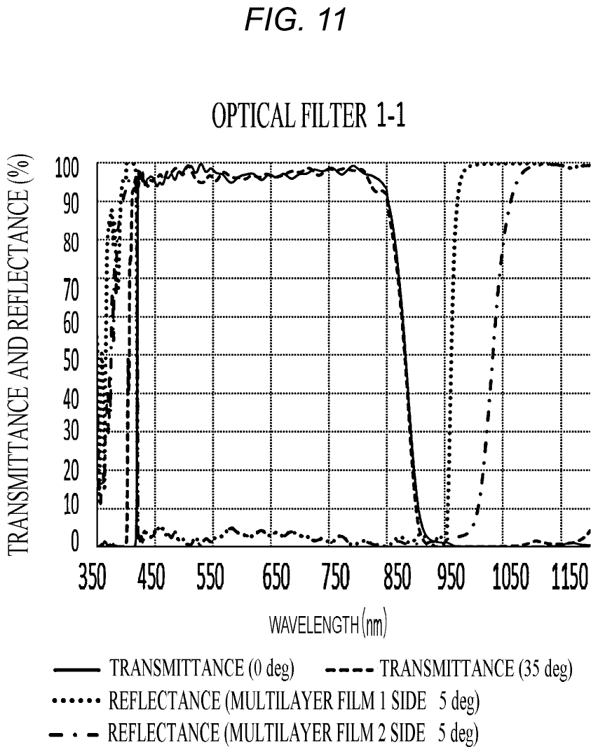

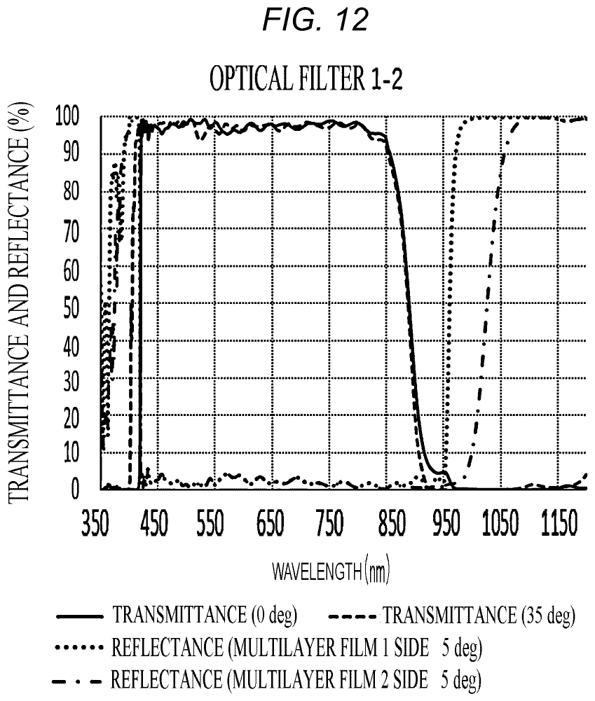

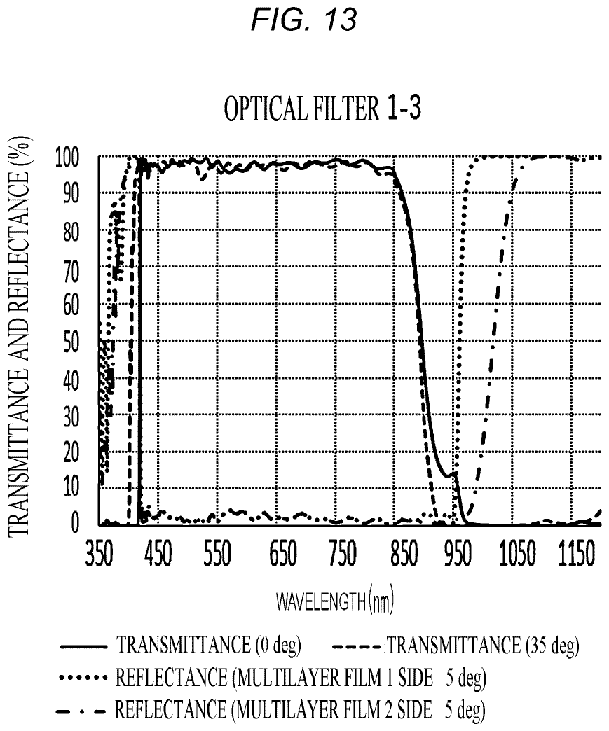

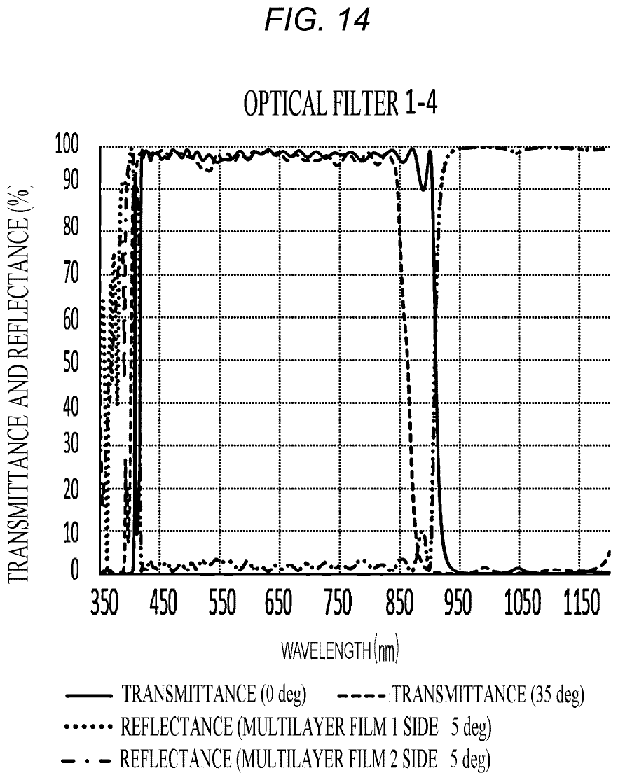

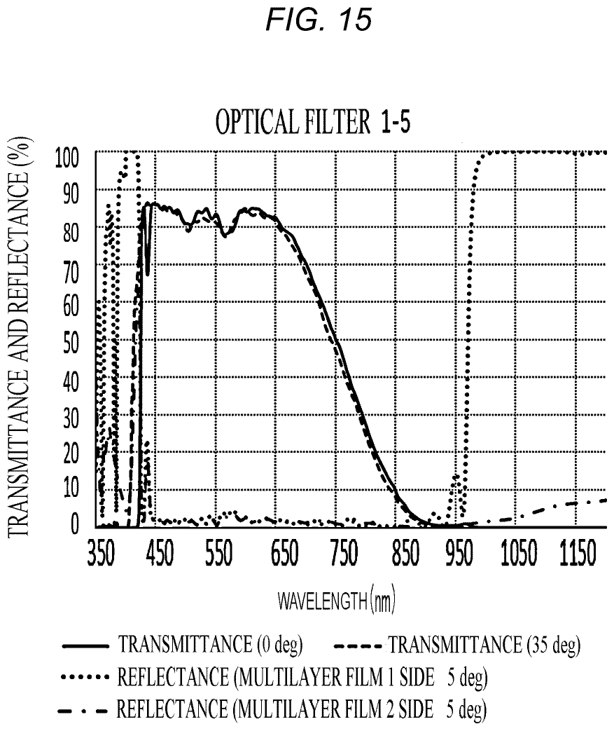

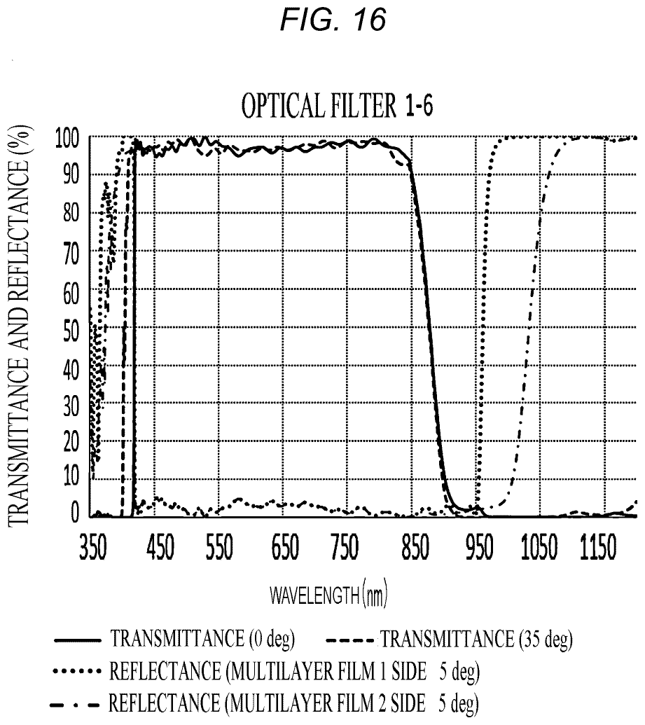

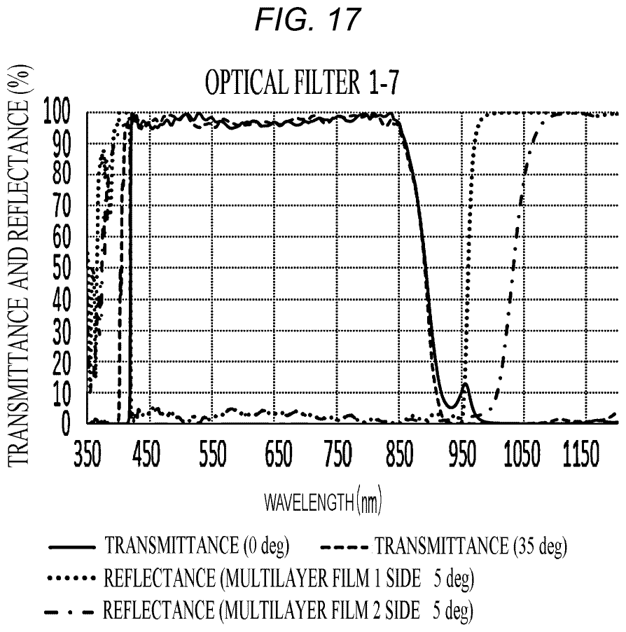

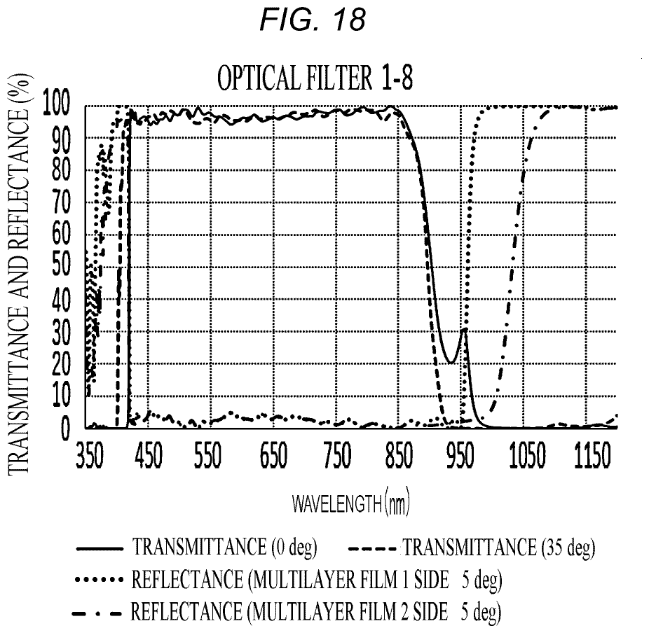

Spectral transmittance (reflectance) curves of the optical filters of Examples 1-1 to 1-8 are illustrated in FIGS. 11 to 18, respectively.

Examples 1-1 to 1-3, 1-6, and 1-7 are inventive examples, and Examples 1-4, 1-5, and 1-8 are comparative examples.

TABLE 6

| | | | Example 1-1 | | Example 1-2 | | Example 1-3 | |
|---|---|---|---|---|---|---|---|---|
| Configuration | Second dielectric | Function | Antireflection | | Antireflection | | Antireflection | |
| of optical filter | multilayer film | Number of layers | 8 | L | 8 | L | 8 | L |
| | | Film thickness | 337 | nm | 337 | nm | 337 | nm |
| | Absorption layer | | None | | None | | None | |
| | Light-absorbing | Glass material type | Yb-containing | | Yb-containing | | Yb-containing | |
| | | | glass 1 | | glass 2 | | glass 3 | |
| | material Y900-1000 | Thickness | 1.25 | mm | 1.25 | mm | 0.8 | mm |
| | First dielectric | Function | Reflection | | Reflection | | Reflection | |
| | multilayer film | Number of layers | 58 | L | 58 | L | 58 | L |
| | | Film thickness | 4,465 | nm | 4,465 | nm | 4,465 | nm |

| | Spectral | R450-600(5 deg)AVE (%) | 1.5 | | 1.5 | 1.5 |
|---|---|---|---|---|---|---|
| | characteristics of | R600-700(5 deg)AVE (%) | 0.8 | | 0.8 | 0.8 |
| | first dielectric | R840-850(5 deg)AVE (%) | 0.1 | | 0.1 | 0.1 |
| | multilayer film | R1000-1200(5 deg)AVE (%) | 99.7 | | 99.7 | 99.7 |
| Spectral | T450-600(0 deg)AVE (%) | | 96.9 | | 97.5 | 97.5 |
| characteristics | T600-700(0 deg)AVE (%) | | 96.6 | | 97.6 | 97.6 |
| | T840-850(0 deg)AVE (%) | | 94.0 | | 95.0 | 96.6 |
| | T930-950(0 deg)MAX (%) | | 1.5 | | 5.3 | 15.2 |
| | \|λIRL(0 deg)(50%)-λIRL(35 deg)(50%)\| (nm) | | 1.0 | | 2.0 | 4.0 |
| | R450-600(5 deg)AVE (%) first dielectric multilayer film side | | 2.7 | | 2.4 | 2.4 |
| | R450-600(5 deg)AVE (%) second dielectric multilayer film | | 2.7 | | 2.4 | 2.4 |
| | side | | | | | |
| | R840-850(5 deg)AVE (%) first dielectric multilayer film side | | 0.1 | | 0.3 | 0.3 |
| | R840-850(5 deg)AVE (%) second dielectric multilayer film | | 0.1 | | 0.3 | 0.3 |
| | side | | | | | |
| | \|10/[λIRL(0 deg)(45%)-AIRL(0 deg)(55%)]\| (nm) | | 2.1 | | 2.1 | 1.9 |
| | R450-600(35 deg)AVE (%) first dielectric multilayer film side | | 2.9 | | 2.7 | 2.7 |
| | R450-600(35 deg)AVE (%) second dielectric multilayer film | | 2.9 | | 2.7 | 2.7 |
| | side | | | | | |
| | R840-850(35 deg)AVE (%) first dielectric multilayer film side | | 1.6 | | 1.7 | 1.7 |
| | R840-850(35 deg)AVE (%) second dielectric multilayer film | | 1.56 | | 1.61 | 1.65 |
| | side | | | | | |
| | R930-1000(5 deg)AVE (%) first dielectric multilayer film side | | 54.73 | | 55.21 | 55.21 |
| | R930-1000(5 deg)AVE (%) second dielectric multilayer film | | 2.7 | | 2.5 | 4.9 |
| | side | | | | | |
| | R1000-1100(5 deg)AVE (%) first dielectric multilayer film | | 99.9 | | 99.9 | 99.9 |
| | side | | | | | |
| | R1000-1100(5 deg)AVE (%) second dielectric multilayer film | | 65.5 | | 71.5 | 78.2 |
| | side | | | | | |
| | | | Example 1-4 | | Example 1-5 | |
| Configuration | Second dielectric | Function | Antireflection | | Antireflection | |
| of optical filter | multilayer film | Number of layers | 8 | L | 8 | L |
| | | Film thickness | 337 | nm | 337 | nm |
| | Absorption layer | | None | | Present | |
| | Light-absorbing | Glass material type | Alkali glass | | Alkali glass | |
| | material Y900-1000 | Thickness | 0.2 | mm | 0.2 | mm |
| | First dielectric | Function | Reflection | | Reflection | |
| | multilayer film | Number of layers | 56 | L | 58 | L |
| | | Film thickness | 4,126 | nm | 4,460 | nm |

| | | | |
|---|---|---|---|
| Spectral | R450-600(5 deg)AVE (%) | 1.3 | 1.5 |
| characteristics of | R600-700(5 deg)AVE (%) | 0.8 | 0.9 |
| first dielectric | R840-850(5 deg)AVE (%) | 1.5 | 0.4 |
| multilayer film | R1000-1200(5 deg)AVE (%) | 99.5 | 99.8 |

| | | | |
|---|---|---|---|
| Spectral | T450-600(0 deg)AVE (%) | 97.8 | 82.7 |
| characteristics | T600-700(0 deg)AVE (%) | 98.4 | 80.4 |
| | T840-850(0 deg)AVE (%) | 98.0 | 11.2 |
| | T930-950(0 deg)MAX (%) | 2.6 | 0.6 |
| | \|λIRL(0 deg)(50%)-AIRL(35 deg)(50%)\| (nm) | 47.0 | 9.0 |
| | R450-600(5 deg)AVE (%) first dielectric multilayer film side | 2.2 | 2.1 |
| | R450-600(5 deg)AVE (%) second dielectric multilayer film side | 2.2 | 1.9 |
| | R840-850(5 deg)AVE (%) first dielectric multilayer film side | 2.1 | 0.4 |
| | R840-850(5 deg)AVE (%) second dielectric multilayer film side | 2.1 | 0.3 |
| | \|10/[λIRL(0 deg)(45%)-λIRL(0 deg)(55%)\| (nm) | 7.2 | 0.4 |
| | R450-600(35 deg)AVE (%) first dielectric multilayer film side | 2.6 | 1.9 |
| | R450-600(35 deg)AVE (%) second dielectric multilayer film | 2.6 | 1.8 |
| | side | | |
| | R840-850(35 deg)AVE (%) first dielectric multilayer film side | 10.0 | 1.9 |
| | R840-850(35 deg)AVE (%) second dielectric multilayer film | 10.03 | 0.55 |
| | side | | |
| | R930-1000(5 deg)AVE (%) first dielectric multilayer film side | 99.53 | 43.15 |
| | R930-1000(5 deg)AVE (%) second dielectric multilayer film | 99.5 | 0.8 |
| | side | | |
| | R1000-1100(5 deg)AVE (%) first dielectric multilayer film side | 99.5 | 99.9 |
| | R1000-1100(5 deg)AVE (%) second dielectric multilayer film | 99.5 | 2.8 |
| | side | | |

TABLE 7

| | | | Example 1-6 | | Example 1-7 | | Example 1-8 | |
|---|---|---|---|---|---|---|---|---|
| Configuration | Second dielectric | Function | Antireflection | | Antireflection | | Antireflection | |
| of optical filter | multilayer film | Number of layers | 8 | L | 8 | L | 8 | L |
| | | Film thickness | 337 | nm | 337 | nm | 337 | nm |
| | Absorption layer | | None | | None | | None | |
| | Light-absorbing | Glass material type | Yb-containing | | 10% Yb: YAG | | 5% Yb: YAG | |
| | material Y900- | | glass 4 | | ceramics | | ceramics | |
| | 1000 | Thickness | 0.56 | mm | 6 | mm | 6 | mm |
| | First dielectric | Function | Reflection | | Reflection | | Reflection | |
| | multilayer film | Number of layers | 58 | L | 58 | L | 58 | L |
| | | Film thickness | 4,465 | nm | 4,465 | nm | 4,465 | nm |

| | | | | |
|---|---|---|---|---|
| Spectral | R450-600(5 deg)AVE (%) | 1.5 | 1.5 | 1.5 |
| characteristics of | R600-700(5 deg)AVE (%) | 0.8 | 0.8 | 0.8 |
| first dielectric | R840-850(5 deg)AVE (%) | 0.1 | 0.1 | 0.1 |
| multilayer film | R1000-1200(5 deg)AVE (%) | 99.7 | 99.7 | 99.7 |

| | | | | |
|---|---|---|---|---|
| Spectral | T450-600(0 deg)AVE (%) | 97.2 | 97.1 | 96.5 |
| characteristics | T600-700(0 deg)AVE (%) | 96.7 | 96.5 | 96.2 |
| | T840-850(0 deg)AVE (%) | 93.6 | 97.4 | 99.0 |
| | T930-950(0 deg)MAX (%) | 2.5 | 10.4 | 28.6 |
| | [λIRL(0 deg)(50%)-λIRL (35 deg)(50%)\| (nm) | 1 | 2 | 5 |
| | R450-600(5 deg)AVE (%) first dielectric multilayer film | 2.7 | 2.7 | 2.7 |
| | side | | | |
| | R450-600(5 deg)AVE (%) second dielectric multilayer | 2.7 | 2.7 | 2.7 |
| | film side | | | |
| | R840-850(5 deg)AVE (%) first dielectric multilayer film | 0.1 | 0.1 | 0.1 |
| | side | | | |
| | R840-850(5 deg)AVE (%) second dielectric multilayer | 0.1 | 0.1 | 0.1 |
| | film side | | | |
| | \|10/[λIRL(0 deg)(45%)-λIRL(0 deg)(55%)\| (nm) | 2.1 | 2.1 | 2.1 |
| | R450-600(35 deg)AVE (%) first dielectric multilayer | 2.9 | 2.9 | 2.9 |
| | film side | | | |
| | R450-600(35 deg)AVE (%) second dielectric multilayer | 2.9 | 2.9 | 2.9 |
| | film side | | | |
| | R840-850(35 deg)AVE (%) first dielectric multilayer | 1.6 | 1.6 | 1.6 |
| | film side | | | |
| | R840-850(35 deg)AVE (%) second dielectric multilayer | 1.6 | 1.6 | 1.6 |
| | film side | | | |
| | R930-1000(5 deg)AVE (%) first dielectric multilayer | 54.7 | 54.7 | 54.7 |
| | film side | | | |
| | R930-1000(5 deg)AVE (%) second dielectric multilayer | 2.7 | 2.7 | 2.7 |
| | film side | | | |
| | R1000-1100(5 deg)AVE (%) first dielectric multilayer | 99.9 | 99.9 | 99.9 |
| | film side | | | |
| | R1000-1100(5 deg)AVE (%) second dielectric multilayer | 65.5 | 65.5 | 65.5 |
| | film side | | | |

From the above-mentioned results, it is understood that the optical filters of Examples 1-1, 1-2, and 1-3 are optical filters in which transmittance of visible light and near-infrared light of 840 nm to 850 nm is excellent, light shielding properties of other near-infrared light in a wavelength region, particularly of 930 nm to 950 nm is excellent, and further a shift of the spectral curve is small even at a high incident angle.

In the optical filter of Example 1-4 in which the light-absorbing material Y₉₀₀₋₁₀₀₀ (ytterbium-containing glass) was not used and light in the near-infrared light region was shielded by the reflection characteristics of the dielectric multilayer film, a result that |λ_{IRL(0deg)(50%)}−λ_{IRL(35deg)(50%)}| exceeded 15 nm, and a spectral curve in a wavelength region of 850 nm to 950 nm shifted depending on an incident angle was obtained.

In the optical filter of Example 1-5 in which the light-absorbing material Y₉₀₀₋₁₀₀₀ (ytterbium-containing glass) was not used and light in the near-infrared light region was shielded by the absorption characteristics of the near-infrared light absorbing dye having the maximum absorption wavelength at 929 nm and the reflection characteristics of the dielectric multilayer film, a result that the average transmittance T_{840-850(0deg)AVE} was lower than 60%, and transmittance of the near-infrared light having a wavelength of 840 nm to 850 nm was low was obtained.

In addition, from the above-mentioned results, it is understood that the optical filters of Examples 1-6 and 1-7 are optical filters in which transmittance of visible light and near-infrared light of 800 nm to 1,000 nm, particularly 800 nm to 900 nm is excellent, light shielding properties of other near-infrared light in a wavelength region, particularly of 1,050 nm to 1,200 nm is excellent, and further a shift of the spectral curve is small even at a high incident angle.

In Example 1-8 in which the 5% Yb:YAG ceramics was used as the light-absorbing material Y₉₀₀₋₁₀₀₀, a result that T_{930-950(0deg)MAX} (%) exceeded 20%, and shielding properties of light at a wavelength of 930 nm to 950 nm was low was obtained.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2022-073742) filed on Apr. 27, 2022, the content of which is incorporated herein by reference.

### INDUSTRIAL APPLICABILITY

The optical filter according to the present invention is excellent in transmittance of visible light and specific near-infrared light, and has shielding properties of specific near-infrared light. In recent years, the optical filter has been useful for applications of information acquisition devices such as cameras and sensors for transport machines, for which high performance has been achieved.

### REFERENCE SIGNS LIST

1A, 1B: optical filter
10: support
21, 22: dielectric multilayer film

What is claimed is:

1. An optical filter comprising:
a light-absorbing material Y₉₀₀₋₁₀₀₀ having a maximum absorption wavelength in a wavelength region of 900 nm to 1,000 nm, and
a dielectric multilayer film, wherein
the optical filter satisfies all of the following spectral characteristics (i-1) to (i-6):
(i-1) in a spectral transmittance curve at a wavelength of 450 nm to 600 nm and an incident angle of 0 degrees, an average transmittance T_{450-600(0deg)AVE} is 60% or more,
(i-2) in a spectral transmittance curve at a wavelength of 840 nm to 850 nm and an incident angle of 0 degrees, an average transmittance T_{840-850(0deg)AVE} is 60% or more,
(i-3) in a spectral transmittance curve at a wavelength of 930 nm to 950 nm and an incident angle of 0 degrees, a maximum transmittance T_{930-950(0deg)MAX} is 20% or less,
(i-4) in a spectral transmittance curve at a wavelength of 850 nm to 950 nm,
a wavelength λ_{IRL(0deg)(50%)} at which a transmittance is 50% at an incident angle of 0 degrees and a wavelength λ_{IRL(35deg)(50%)} at which a transmittance is 50% at an incident angle of 35 degrees satisfy the following relational expression:
$$\vert {λ}_{I R L ( 0 deg ) ( 50 \% )} - {λ}_{I R L ( 35 deg ) ( 50 \% )} \vert \leq 15 nm ,$$
(i-5) in a spectral reflectance curve at a wavelength of 450 nm to 600 nm and an incident angle of 5 degrees, an average reflectance R_{450-600(5deg)AVE} measured from at least one main surface is 10% or less, and
(i-6) in a spectral reflectance curve at a wavelength of 840 nm to 850 nm and an incident angle of 5 degrees, an average reflectance R_{840-850(5deg)AVE} measured from at least one main surface is 10% or less.

2. The optical filter according to claim 1, wherein the optical filter further satisfies the following spectral characteristic (i-7):
(i-7) in a spectral transmittance curve at a wavelength of 850 nm to 950 nm and an incident angle of 0 degrees,
a wavelength λ_{IRL(0deg)(55%)} at which a transmittance is 55% and a wavelength λ_{IRL(0deg)(45%)} at which a transmittance is 45% satisfy the following relational expression:
$$\vert 10 / [ {λ}_{IRL ( 0 deg ) ( 45 \% )} - {λ}_{IRL ( 0 deg ) ( 55 \% )} ] \vert \geq 1.5 .$$

3. The optical filter according to claim 1, wherein the optical filter further satisfies the following spectral characteristics (i-8) and (i-9):
(i-8) in a spectral reflectance curve at a wavelength of 450 nm to 600 nm and an incident angle of 35 degrees, an average reflectance R_{450-600(35deg)AVE} measured from at least one main surface is 10% or less, and
(i-9) in a spectral reflectance curve at a wavelength of 840 nm to 850 nm and an incident angle of 35 degrees, an average reflectance R_{840-850(35deg)AVE} measured from at least one main surface is 10% or less.

4. The optical filter according to claim 1, wherein the optical filter further satisfies the following spectral characteristic (i-10):
(i-10) in a spectral reflectance curve at a wavelength of 930 nm to 1,000 nm and an incident angle of 5 degrees, an average reflectance R_{930-1000(5deg)AVE} measured from at least one main surface is 5% or more.

5. The optical filter according to claim 1, wherein the optical filter further satisfies the following spectral characteristic (i-11):
(i-11) in a spectral reflectance curve at a wavelength of 1,000 nm to 1,100 nm and an incident angle of 5 degrees, an average reflectance R_{1000-1100(5deg)AVE} measured from at least one main surface is 5% or more.

6. The optical filter according to claim 1, wherein the light-absorbing material Y₉₀₀₋₁₀₀₀ has a plate shape having a thickness of 3 mm or less.

7. The optical filter according to claim 1, wherein the light-absorbing material Y₉₀₀₋₁₀₀₀ satisfies the following spectral characteristic (iii-1):
(iii-1) an average optical density OD_{940-960 AVE} at a wavelength of 940 nm to 960 nm/an average optical density OD_{840-860_AVE} at a wavelength of 840 nm to 860 nm>5.

8. The optical filter according to claim 1, wherein the light-absorbing material Y₉₀₀₋₁₀₀₀ satisfies the following spectral characteristic (iii-2):
(iii-2) an average optical density OD_{920-930_AVE} at a wavelength of 920 nm to 930 nm/an average optical density OD_{870-880_AVE} at a wavelength of 870 nm to 880 nm>3.

9. An imaging device comprising the optical filter according to claim 1.

10. An imaging device comprising:
the optical filter according to claim 1; and
a band pass filter comprising a visible light transmission band comprising a wavelength region of 450 nm to 650 nm and a near-infrared light transmission band comprising a wavelength region of 840 nm to 850 nm.
